(19) United States
(12) Patent Application Publication
(10) Pub. No.: US 2014/0129745 A1
(43) Pub. Date: May 8, 2014

(54) ASYMMETRIC FIFO MEMORY

(71) Applicant: NVIDIA CORPORATION, Santa Clara, CA (US)

(72) Inventor: Robert A. Alfieri, Chapel Hill, NC (US)

(73) Assignee: NVIDIA CORPORATION, Santa Clara, CA (US)

(21) Appl. No.: 13/672,596

(22) Filed: Nov. 8, 2012

(51) Int. Cl. G06F 3/00

(52) U.S. Cl. 710/53

(57) ABSTRACT

A First-in First-out (FIFO) memory comprising a latch array and a RAM array, the latch array being assigned higher priority to receive data than the RAM array. Incoming data are pushed into the latch array while the latch array has vacancies. Upon the latch array becoming empty, incoming data are pushed into the RAM array during a spill-over period. The RAM array may comprise two spill regions with only one active to receive data at a spill-over period. The allocation of data among the latch array and the spill regions of the RAM array can be transparent to external logic.

### TECHNICAL FIELD

The present disclosure relates generally to the field of automatic generation of data storage, and, more specifically, to the field of automatic generation of First-in First-out (FIFO) memory.

### BACKGROUND

In integrated circuits designed to process data, FIFO memories are typically used to store data between processing states. In hardware form, a FIFO primarily consists of a set of read and write pointers, storage and control logic. The storage may be based on RAM cells in one example or built-in logic storage in another example, such as flip-flops or latches, or any other suitable form of storage elements.

In a conventional FIFO generator that produces synthesizable code, FIFO designs in integrated circuits (ICs) are optimized by area and not so much by power. RAM arrays provide the benefit of large storage capacity. However, they are usually placed on the edge of the IC partition and typically far away from the logic that uses the FIFO. Thus, data transmission to and from RAM cells consumes relatively high dynamic power through the long interconnect paths from the using logic to the RAM cells. Also, a RAM array itself may have long internal paths, further contributing to high dynamic power consumption. In contrast, flip-flops or latches are built into or near the using logic and have relatively short interconnect and internal paths. Thus they provide the advantages of low dynamic power consumption and fast speed, but usually are not used in large volume storage because they consume large areas and are expensive.

With medium to large FIFOs, a FIFO generator calls a RAM generator to instantiate real RAM cells for the RAM. FIFOs are usually sized with large capacities for maximum performance, being able to handle the worst scenarios. However, it is observed that these FIFOs are often empty or near empty in many periods, e.g. 70% of the working time they may be empty or near empty, even after area optimization.

It would be advantageous to provide an option in a generator to produce a FIFO memory that consumes reduced dynamic power as well as area.

### SUMMARY OF THE INVENTION

Accordingly, embodiments of the present disclosure provide an asymmetric FIFO memory comprising a built-in logic storage array, e.g. latches or flip-flops, and a RAM array that consumes reduced dynamic power. The RAM may be located along the IC peripherals while the latch array is disposed close to the logic that uses the FIFO. Embodiments of the present disclosure advantageously include a mechanism to alternate the data entry between the two constituent arrays (a built-in logic storage array and a RAM array) with maximized usage of the built-in logic storage array and without introducing complication of the logic that uses the FIFO.

In one embodiment of present disclosure, an asymmetric FIFO comprises an input, an output, a first memory block comprising a plurality of built-in logic storage units, a second memory block consisting of a plurality of RAM cells, and a FIFO control logic configurable to control usage of the two memory blocks. Incoming data are pushed into the first memory block upon said first memory block being evaluated to be empty until said first memory block is evaluated to be full. Upon the first memory block being full, data are pushed into the second memory block during a spill-over period until the first memory block is empty. The second memory block may comprise more than one spill region and yet only one spill region remains active to receive data at a time. In this way, data is biased toward the first memory block over the second memory block.

In another embodiment of present disclosure, a method for buffering data using a FIFO memory comprises a) buffering data to and from a first memory block while it has vacancies; b) upon the first memory block becoming full, buffering data to a first spill region of the second memory during a spill-over period; c) during the spill-over period, buffering data to the first spill region upon the first memory block becoming empty; and d) draining data out of the first and second memory blocks in accordance with a storage order of data. In this embodiment, the first memory block is a latch array or a flip-flop array while the second memory block is a RAM array.

In another embodiment of present disclosure, a computer is capable of obtaining configuration input from a user, generating a synthesizable code representing an asymmetric FIFO memory. The FIFO memory includes an input operable to receive data to be buffered, a first memory block comprising a plurality of latches and/or flip-flops, a second memory block comprising a plurality of RAM cells, and a logic configurable to control the usage of the memory blocks. The asymmetric FIFO memory is operable to a) buffer data to and from the first memory block while the first memory block has vacancies; b) upon the first memory block becoming full, buffering data to a first spill region of the second memory during a spill-over period; c) during the spill-over period, buffering data to the first spill region upon the first memory block becoming empty and using the first memory block to store data; and d) draining data out of the memory blocks in accordance with a storage order of said data.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates a block diagram of a partial integrated circuit that comprises an asymmetric FIFO memory in accordance with an embodiment of the present disclosure.

FIG. 1B illustrates a block diagram of an asymmetric FIFO memory in accordance with an embodiment of the present disclosure.

FIG. 2 is a flow diagram illustrating an exemplary data allocation mechanism in the asymmetric FIFO memory during a buffering process in accordance with an embodiment of the present disclosure where the RAM array has one spill region.

FIG. 3 is a flow diagram illustrating an exemplary data allocation mechanism in the asymmetric FIFO during a buffering process in accordance with an embodiment of the present disclosure where the RAM array has two spill regions.

FIG. 4a-4f are state diagrams illustrating the sequence of data buffering process in an asymmetric FIFO memory in accordance with an embodiment of the present disclosure where one spill region is defined in the RAM array.

FIG. 5a-5k are state diagrams illustrating the sequence of data buffering process in an asymmetric FIFO memory in accordance with an embodiment of the present disclosure where two spill regions are defined in the RAM array.

FIG. 6 illustrates a block diagram of a computing system including a synthesized code generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Asymmetric FIFO Memory

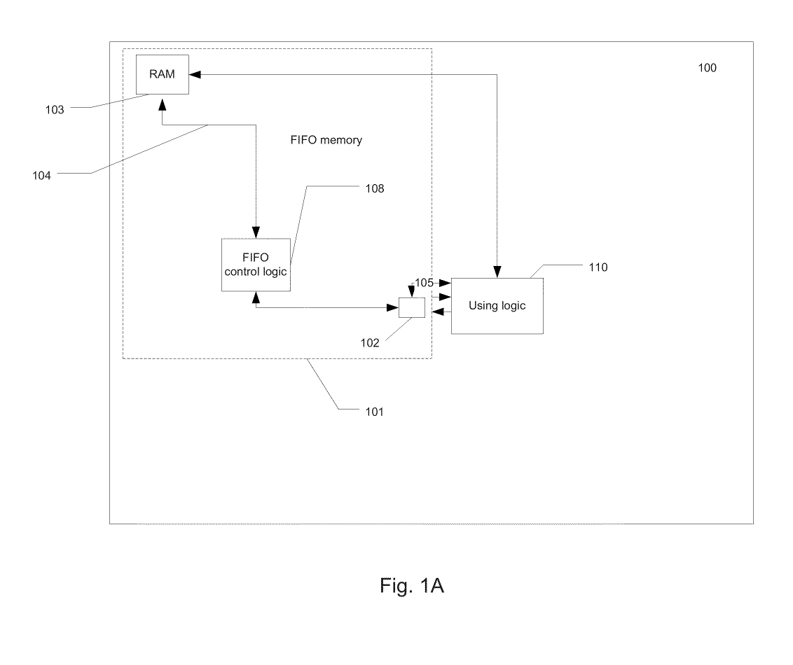

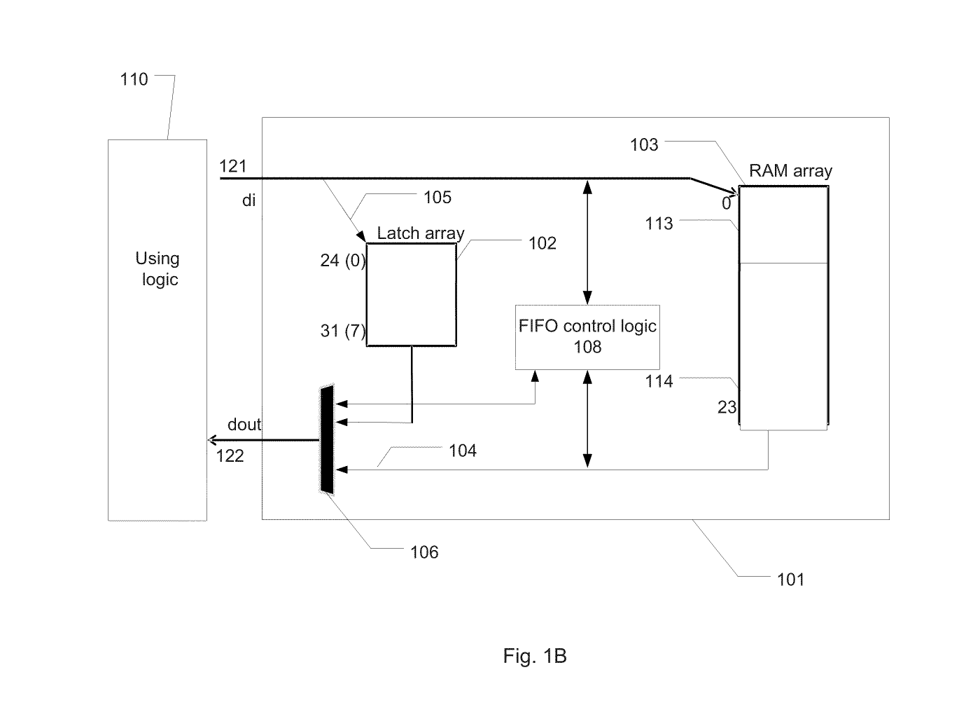

FIG. 1A illustrates a block diagram of a partial integrated circuit 100 that comprises an asymmetric FIFO memory 101 in accordance with an embodiment of the present disclosure. The integrated circuit 100 comprises a using logic 110 that produces and consumes a stream of buffered data, and an asymmetric FIFO memory 101 including a latch or flip-flop array 102, a RAM array 103, and a FIFO control logic 108. Array 102 may be called a sequential circuit array. The using logic can be any system, e.g. an imaging processing system, graphic display system, audio playback system, data compressing/decompressing system, or any other types of digital integrated circuits. As shown in FIG. 1A, the latch array 102 is disposed in the vicinity of, or even within, the using logic 110 and thus communicates with the using logic with short interconnect lines 105. The RAM array 103 on the other hand is disposed at the edge of a partition and distant from the using logic 110, and communicates with the using logic on long interconnect wires 104.

Although for purposes of illustration, the asymmetric FIFO 101 is described to contain only one latch array and one RAM array, there is no limit on the number of each category of arrays that the FIFO 101 may comprise in order to implement this disclosure. In some embodiments, the latch array 102 can be replaced with a flip-flop array or combined with a flip-flop array, as flip-flops share the advantage of consuming relatively low dynamic power. As described further below, in accordance with embodiments of the present disclosure, the latch array 102 is used predominantly when available to store data, and the RAM array 103 is used during spill-over periods when the latch array 102 is full. FIFO control logic 108 makes this sharing between the RAM array 103 and the latch array 102 completely transparent to using logic 110.

FIG. 1B illustrates a block diagram of an asymmetric FIFO memory 101 in accordance with an embodiment of the present disclosure. The asymmetric FIFO 101 comprises an input 121, an output 122 coupled to a MUX 106, a latch array 102, a RAM array 103, and a FIFO control logic 108. For purposes of illustration, the latch array 102 is 8-bit deep and the RAM array is 24-bits for example, with the RAM cells assigned for lower addresses and the latch array for the upper addresses. However, there are no particular requirements on the width or the depth of either unit that can be used. And the address allocation is similarly exemplary only as far as the present disclosure is concerned.

In some embodiments, the asymmetric FIFO memory 101 can be configured to be a programmable FIFO capable of performing specific operations on the buffered data before the data are output. Further, in some embodiments, the asymmetric FIFO memory 101 can be configured as a synchronous memory. In some embodiments, the asymmetric FIFO memory 101 can be configured as a multi-threaded FIFO with shared credits or dedicated credits.

The FIFO control logic 108 operates to combine the latch array 102 and the RAM array 103 into an asymmetric FIFO memory 101 which buffers the data for the using logic through the input 121 and the output 122 in a manner transparent to using logic 111. The stream of incoming data are received at the input 121 sequentially, pushed and stored into the FIFO memory 101. The stored data can later be read, or consumed, by a using logic 110 through the output 122 and the MUX 106 in the same order as being pushed in. The FIFO control logic 108 disclosed herein can be implemented as a circuit, an application program or a combination of both.

The allocation of the data among the constituent storage units inside the asymmetric FIFO 101, namely the latch array 102 and the RAM array 103, can be transparent to the using logic 110, as well as any other logic that communicates with the asymmetric FIFO 101. Moreover, the using logic 110 may only see a FIFO memory 101 having one input and one output without regards to the asymmetric FIFO's 101 internal allocation mechanism.

Internally, the FIFO control logic 108 can operate to manage and control the flow of data and allocate incoming data to either the latch array 102 or the RAM array 103 based on the status of the two units. To make efficient use of the latch array 102 which typically consumes much less dynamic power than the RAM array 103, the latch array 102 is assigned with higher use priority to receive data than the RAM array 103. Once the latch array 102 is full, the subsequent incoming data is pushed into a spill region, 113 or 114, of the RAM array. In some embodiments, the entire RAM array 103 can be defined as one spill region. In some other embodiments, it can have two or even more spill regions. In some embodiments, the spill regions can be fixed partitions of the RAM array 103; while in some others, they can be dynamic partitions of the RAM array 103.

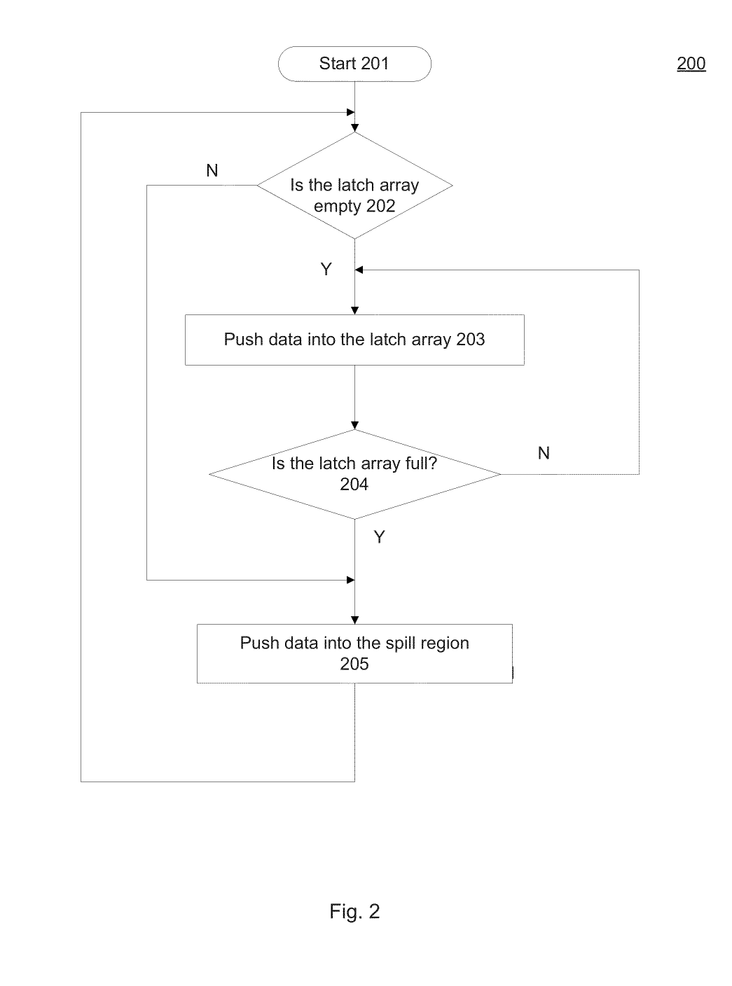

FIG. 2 is a flow diagram illustrating a data allocation procedure 200 in the asymmetric FIFO memory during a buffering process in accordance with an embodiment of the present disclosure where the RAM array 103 has one spill region. The FIFO control logic 108 follows this procedure 200. At block 201, the input of the asymmetric FIFO 101 receives a stream of data at start. If the latch array is determined to be empty at block 202, incoming data are pushed into the latch array at block 203 and then consumed, until it is determined that the latch array is full at block 204.

An empty status may be declared when either no data has been stored in it or the stored data have all been consumed by a using circuit. In some other embodiments, the latch array 102 can be defined as empty when a certain number of entries have been consumed. A full status may be declared when every entry has been written to and not consumed.

If the latch array is determined to be full, the subsequent data is pushed into the spill region of the RAM in block 205. The data is continued to be pushed into the spill region until the latch array becomes empty in block 205. Once the latch array is evaluated to be empty in block 202, the subsequent data is pushed into the latch array as in block 203 and the operations in foregoing blocks 202-205 are repeated.

In some embodiments, especially those that employ less complicated FIFO control logic to keep track of the ordering of data for economical purposes, pushing data into the spill region in block 205 is put off until the spill region is determined to be completely drained. This may undesirably slow down the data transmission speed.

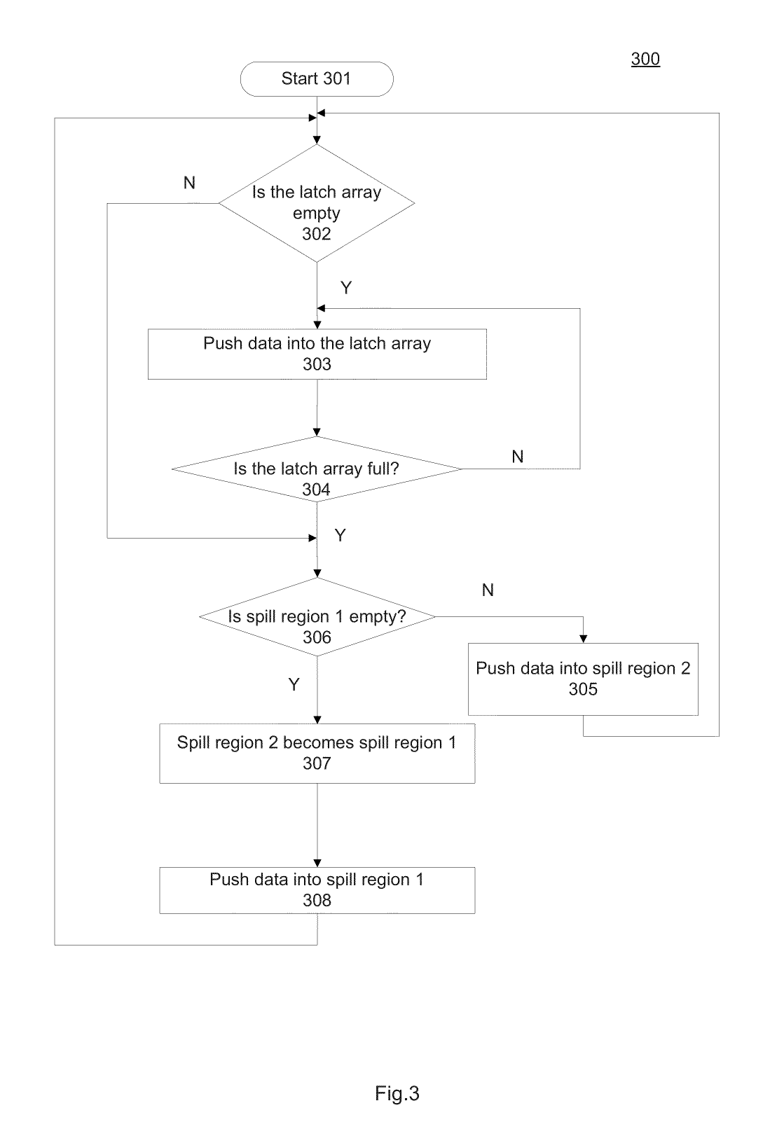

Thus, in order to further maximize the usage of the latch array, two or more spill regions can be allowed in the RAM array. FIG. 3 is a flow diagram illustrating a data allocation procedure 300 in the asymmetric FIFO during a buffering process in accordance with an embodiment of the present disclosure where the RAM array has two spill regions, e.g., spill region 1 and spill region 2. At start in block 301, the input of the asymmetric FIFO receives a stream of data. The latch array is evaluated at block 302. If it is determined to be empty, the incoming data are pushed into and consumed from the latch array as in block 303, until it is determined to be full in block 304. If the latch array is not empty in block 302, the data will be pushed to an available RAM array, i.e., the spill region 1 or the spill region 2.

Once the latch array is determined to be full in block 304, the subsequent data are pushed into a spill region of the RAM array. Thus, if spill region 1 is determined to be empty in block 306, there is only one spill region in the RAM array because spill region 2 becomes spill region 1 in block 307. Thus the subsequent data are pushed into spill region 1 in block 308 until the latch array is determined to be empty again in block 302 again. In the later event, the latch array will take over and receives the next data in block 303. The operations in foregoing blocks are then repeated.

Since spill region 1 has to drain before the latch array can drain due to the entry ordering of the FIFO data, once the latch array is determined to be empty, in some embodiment, it can be determined automatically that spill region 1 is empty at block 306 and accordingly spill region 2 can become spill region 1. In other words, the assertion of an empty latch array operates to trigger the merge of the spill regions.

Moreover, if the latch array is determined to be full in block 303, and the spill region 1 has not been drained as determined in block 304, the subsequent data are pushed into spill region 2 of the RAM until the latch array becomes empty and available again as determined in block 302. In the later event, the latch array will take over and receives the next data as in block 302. The operations in foregoing blocks are then repeated.

If the spill region 1 of the RAM array is evaluated to be empty during the time spill regions 2 is active to receive data, spill region 2 merges with spill region 1 and becomes spill regions 1. Then the foregoing steps are repeated.

By keeping only one spill region active to receive data at a time, data can be pushed into the latch array as soon as it is determined to be empty. However, in some other embodiments, more than one spill regions can be active at a time.

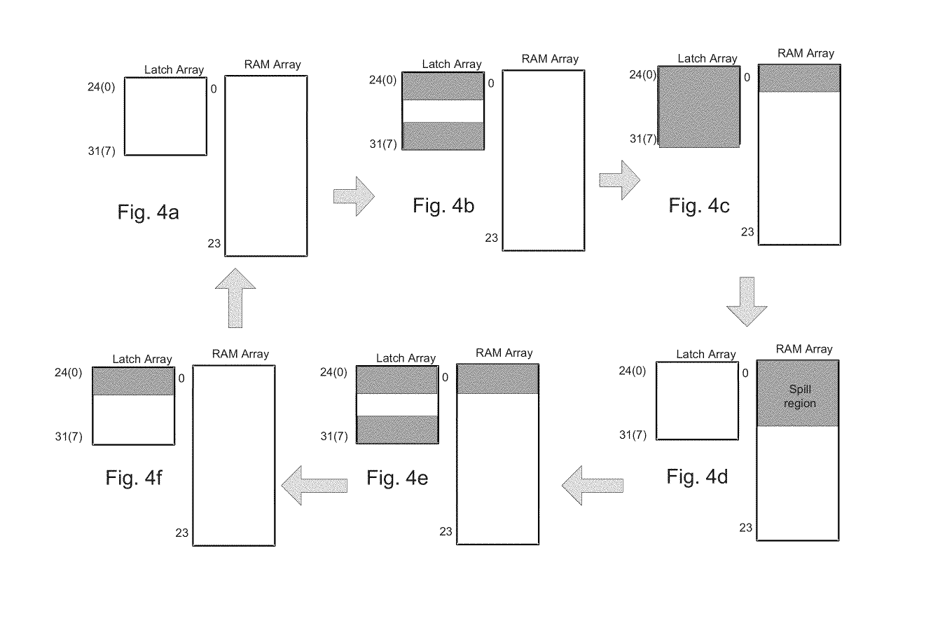

FIGS. 4a-4f are state diagrams illustrating the sequence of data buffering processes in an asymmetric FIFO memory in accordance with an embodiment of the present disclosure where one spill region is defined in the RAM array. The latch array and the RAM array in FIG. 4 correspond to the latch array 102 and the RAM array 103 in FIG. 1B respectively. Both units start as empty as in FIG. 4a, so the incoming data are pushed into and consumed from the latch array first as in FIG. 4b. As the latch array subsequently becomes full as shown in FIG. 4c, data are spilled to the spill region in the RAM array as shown in FIG. 4d. Since the data stored in the latch array entered the asymmetric FIFO before those stored in the spill region at this point, the latch array is drained before the RAM array, as also shown in FIG. 4d. Determination of an empty status of the latch array can trigger the FIFO control logic to switch to using the latch array from using the RAM array. Therefore subsequent data enter the latch array as shown in FIG. 4e. Since the data stored in RAM array entered the FIFO before those stored in the latch array at this point, the RAM cell is drained first, as shown in FIG. 4f. Eventually both units become empty when no more new data enter the FIFO. The state as shown in FIG. 4a is restored. The foregoing steps as illustrated in FIG. 4a-FIG. 4f are repeated then.

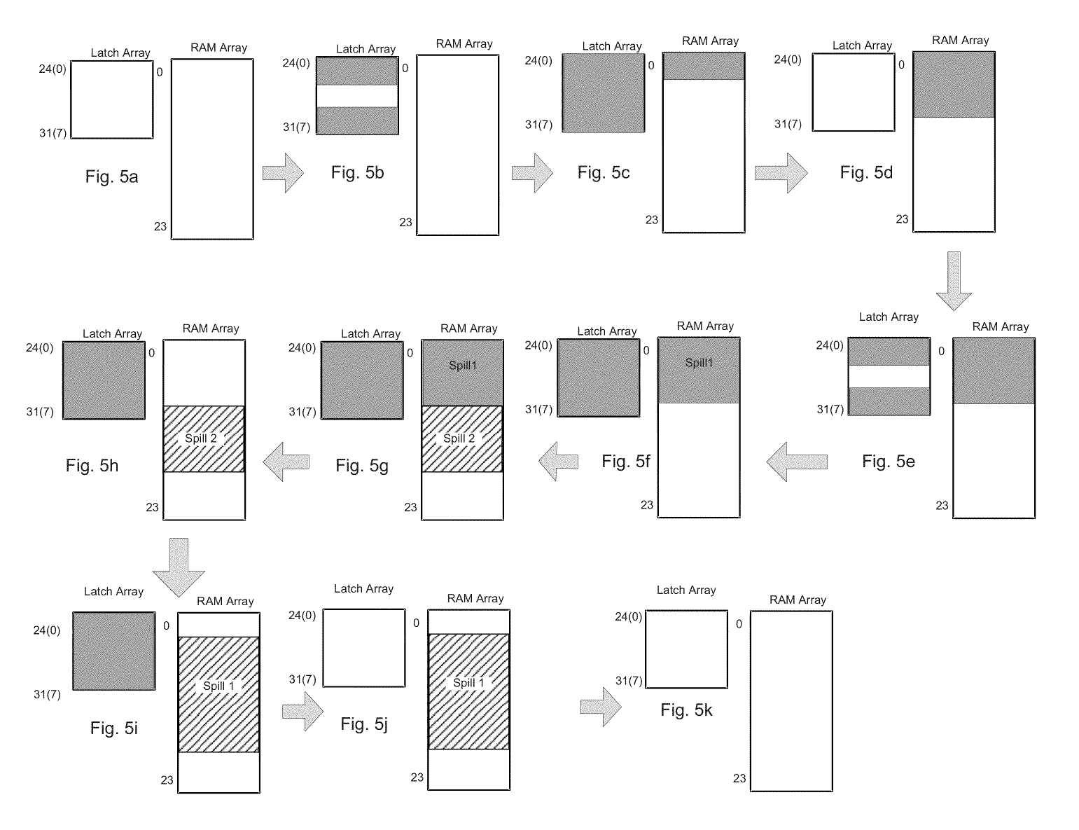

FIGS. 5a-5k are state diagrams illustrating the sequence of data buffering process in an asymmetric FIFO memory in accordance with an embodiment of the present disclosure where two spill regions are defined in the RAM array. FIGS. 5a-5e depict the same data buffer process as FIGS. 4a-4e correspondingly. When the latch array becomes full again in FIG. 4f, spill region 1 may still contain stored data not being consumed, or not drained. Then subsequent incoming data are then pushed into spill region 2, as FIG. 5g shows. Because the data stored in spill region 1 entered the asymmetric FIFO before those stored in the latch array and the spill regions 2 array at this point, spill region 1 is drained first as FIG. 5h shows. Determination of an empty status of the spill region 1 may trigger the FIFO control logic to merge the two spill regions and thereby spill region 2 is redefined as spill region 1 as FIG. 5i shows. As data continue to be pushed into the merged spill region (FIG. 5i), the data stored in the latch array are consumed and become empty again (FIG. 5j). Eventually, all the data in the FIFO are consumed as shown in FIG. 5k which is the same status as shown in FIG. 5a. The foregoing steps as illustrated in FIG. 5a-FIG. 5k are repeated then.

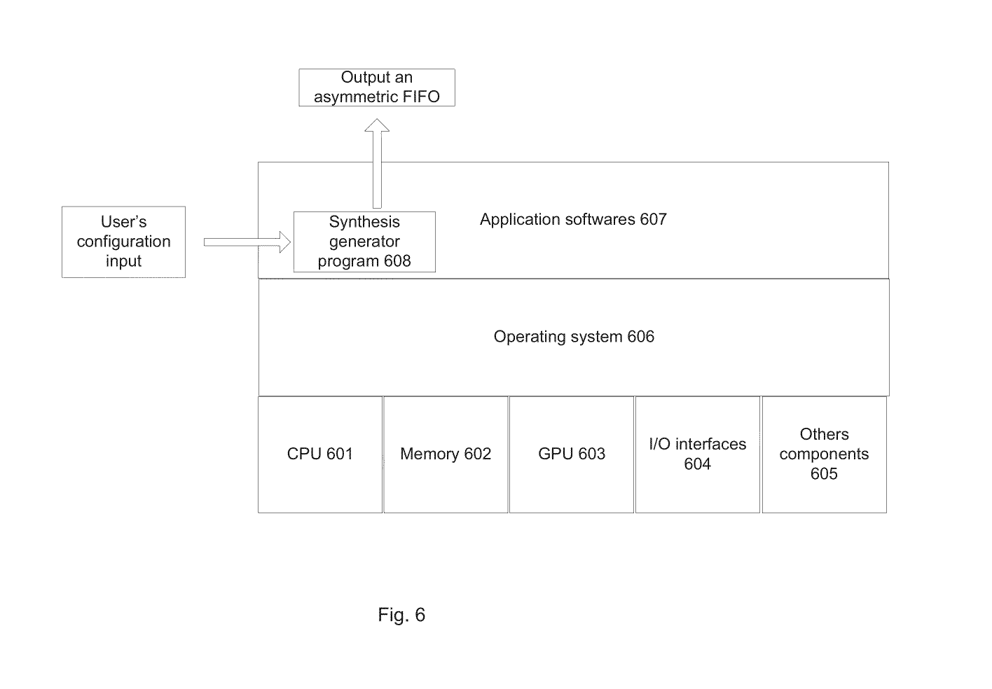

The asymmetric FIFO memory as well as associated circuitry disclosed herein can be produced automatically by a synthesizable code generator, such as VHDL, Verilog, or other hardware description languages known to those skilled in the art. FIG. 6 illustrates a block diagram of a computing system including a synthesized code generator in accordance with an embodiment of the present disclosure. The computing system comprises a processor 601, a system memory 602, a GPU 603, I/O interfaces 604 and other components 605, an operating system 606 and application softwares 607 including a synthesis generator program 608 stored in the memory 602. When incorporating the user's configuration input and executed by the processor 601, the generator program 608 produces a synthesizable code representing an asymmetric FIFO memory. The synthesizable code may be combined with other code, either produced by a generator program or authored by a programmer, to produce synthesizable code for an integrated circuit. Synthesizable code may be written in Verilog, VHDL, or other hardware description languages known to those skilled in the art.

The generator program comprises components that are used to produce corresponding components of synthesizable code, such as a RAM generator, sender interface code generator and a receiver interface code generator, and a FIFO generator (not shown). When executed by CPU, the storage code generator produces synthesizable storage code. Generally, the RAM generator code is used to synthesize or instantiate the storage resources within the asymmetric FIFO memory, e.g. flip flops, latches, RAM or the like.

The FIFO generator provides an option to manually divide the asymmetric into a normal RAM array, for example, for the lower address and a sequential circuit or latch array for the upper addresses in accordance with those embodiments disclosed herein. The FIFO generator can lay down a RAM wrapper that looks like a normal RAM, but transparently handles the data flow among the constituent storage units within the FIFO as discussed within the embodiments of the present disclosure.

Table 1 is an exemplary synthesizable code of one FIFO instance in accordance with an embodiment of the present disclosure.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A First-in First-out (FIFO) memory comprising:
an input configured to receive data to be buffered;
a first memory block comprising a plurality of sequential logic storage units;
a second memory block consisting of a plurality of Random Access Memory (RAM) cells;
a first logic coupled to, and configurable to control usage of, said first memory block and said second memory block, wherein:
said data are pushed into said first memory block upon said first memory block being evaluated to be contain vacancies until said first memory block is evaluated to be full;
upon said first memory block being evaluated to be full, pushing said data to said second memory block during a spill-over period until said first memory block is evaluated to be empty and then using said first memory block; and
an output configured to drain said data being buffered in accordance with an entry order of said data.

2. The FIFO memory as described in claim 1 wherein said first memory block has less capacity than said second memory block.

3. The FIFO memory as described in claim 1 wherein said sequential logic storage units are latches and/or flip-flops.

4. The FIFO memory as described in claim 1 wherein said first and said second memory blocks are configured as synchronous FIFO memories.

5. The FIFO memory as described in claim 1 wherein said first memory block is disposed near or within circuitry that uses said data, and wherein said second memory block is disposed proximate to an integrated circuit peripheral.

6. The FIFO memory as described in claim 1 wherein said first memory block consumes less dynamic power and performs faster than said second memory block.

7. The FIFO memory as described in claim 1,
wherein said second memory block comprises a first spill region and a second spill region; and
wherein said pushing said data to said second memory block during a spill-over period comprises:
pushing said data into said first spill region until said first memory block is evaluated to be empty; and
upon said first memory block being evaluated to be full and said first spill regions being evaluated to be not empty, pushing said data into said second spill region until said first memory block is evaluated to be empty.

8. The FIFO memory as described in claim 7, wherein said second spill region merges with said first spill region upon said first spill region being determined to be empty.

9. The FIFO memory as described in claim 1 wherein said first and said second memory blocks are treated as one FIFO storage entity by external circuitry.

10. A method of buffering data using a FIFO memory comprising:
a) buffering data to and from a first memory block while said first memory block has vacancies;
b) upon said first memory block becoming full, buffering data to a first spill region of a second memory during a spill-over period;
c) during said spill-over period, buffering said data to said first spill region upon said first memory block becoming empty; and
d) during said b) and said c) draining data out of said first and second memory blocks in accordance with a storage order of said data.

11. The method as described in claim 10 further comprising buffering said data to a second spill region of said second memory block during said spill-over period upon said first memory block being determined to be full and said first spill region being determined to be not empty.

12. The method as described in claim 11 wherein only one of said first spill region and said second spill region remains active to receive data during said spill-over period.

13. The method as described in claim 11 further comprising merging said second spill region with said first spill region upon said first spill region being determined to be empty.

14. The method as described in claim 10 wherein said first memory block comprises a plurality of latches or flip-flops, and wherein said second memory block comprises a plurality of RAM cells.

15. The method as described in claim 10 wherein said first and said second memory blocks are treated as one FIFO storage entity by the external circuitry.

16. The method as described in claim 10 wherein said first and second spill regions are dynamic partitions of said second memory block.

17. A computer readable non-transient storage medium storing instructions for causing a processor to produce synthesizable code representing a FIFO memory by performing the operations of:
obtaining configuration input from a user;
generating a first portion of the synthesizable code representing an input operable to receive data to be buffered by said FIFO memory;
generating a second portion of the synthesizable code representing a first memory block comprising a plurality of latches and/or flip-flops;
generating a third portion of the synthesizable code representing a second memory block comprising a plurality of RAM cells;
generating a fourth portion of the synthesizable code representing logic coupled with and configurable to control the usage of said first memory block and said second memory block, wherein said logic is operable to perform:
a) buffering data to and from a first memory block while said first memory block has vacancies;
b) upon said first memory block becoming full, buffering data to a first spill region of second memory during a spill-over period;
c) during said spill-over period, buffering data to said first spill region upon said first memory block becoming empty; and
d) during said b) and said c) draining data out of said first and second memory blocks in accordance with a storage order of data.

18. A computer readable non-transient storage medium as described in claim 17,
wherein said logic is further operable to perform buffering of data to a second spill region of second memory during said spill-over period when said first spill region is not empty; and
wherein only one of said first spill region and said second spill region remains active to receive data during said spill-over period.

19. A computer readable non-transient storage medium as described in claim 18, wherein said second spill region merges with said first spill region upon said first spill region becoming empty.

20. A computer readable non-transient storage medium as described in claim 17, wherein said synthesizable code further laying down a RAM wrapper that resembles a normal RAM but transparently buffers data among said first and said second memory blocks.
